(19) United States
(12) Patent Application Publication
(10) Pub. No.: US 2003/0220011 A1
(43) Pub. Date: Nov. 27, 2003

(54) Modular connector for a data communications system enabling near-end crosstalk to be adjusted

(76) Inventor: Jacques Hambersin, Montigni-Le-Tilleul (BE)

Correspondence Address: Joseph Sofer, SOFER & HAROUN, L.L.P., Suite 910, 317 Madison Avenue, New York, NY, 10017, US

(21) Appl. No.: 10/336,661

(22) Filed: Jan. 3, 2003

(30) Foreign Application Priority Data
Jan. 24, 2002 (FR) 02 01117

(51) Int. Cl. H01R 4/24

(52) U.S. Cl. 439/418

(57) ABSTRACT

The present invention relates to a modular connector for a data communications system, the connector comprising a cap receiving a multi-pair cable, and in which the conductor pairs are released from an outer sheath of the cable in order to be fixed in a terminal receiver element that co-operates with a housing carrying insulation-displacement contacts, the connector also having a conductive arrangement placed between the end of said sheath and said receiver element and separating each pair of conductors. According to the invention, said conductive arrangement is constituted by tubular shields each receiving one pair of conductors and each of a length that is adjusted individually so as to obtain determined levels of near-end crosstalk between pairs.

The present invention relates to a modular connector for a data communications system enabling near-end crosstalk to be adjusted.

### BACKGROUND OF THE INVENTION

Data communications systems and networks generally transmit data at high rates over a plurality of circuits comprising data communications cables which are multi-pair cables, i.e. they have distinct insulated electrical conductors twisted together in pairs. These twisted pairs are often terminated in a modular connector (e.g. a modular connector as used by telephones or computers), which connector must comply with the electrical, dimensional, and mechanical performance criteria required by industrial standards such as IEC 60603-7. At high data rates, each electrical conductor circuit both transmits and receives electromagnetic radiation, such that the signals conveyed by a conductor pair or circuit can be coupled with the signals conveyed by another conductor pair. This undesirable electromagnetic coupling between the signals of different conductor pairs of different electrical circuits is known as “crosstalk”. The problem of crosstalk increases with increasing signal frequency. This interference is measured in decibels (dB) and is referred to as near-end crosstalk (NEXT).

When considering a connector in such a data communications circuit, there can be a certain amount of crosstalk within the connector. Furthermore, regardless of whether such connectors are male or female, they are modular or standardized and they satisfy standards which define amongst other things their outside dimensions and the acceptable levels of near-end crosstalk.

Connectors are categorized depending on signal frequency, and for each category an acceptable range of near-end crosstalk is defined.

For example, category 5 of the TIA/EIA 568 standard corresponds to maximum operating frequencies of up to 100 megahertz (MHz), category 6 corresponds to maximum frequencies of up to 250 MHz, and category 7 corresponds to maximum frequencies of up to 600 MHz.

For category 6, the TIA-EIA 568 standard (known as the “deembedded method”) specifies that near-end crosstalk between pairs 1 and 3 must lie in the range 36.4 dB to 37.6 dB at 100 MHz, between pairs 1 and 2 and between pairs 1 and 4 it must be greater than 57 dB at 100 MHz, between pairs 2 and 3 and between pairs 3 and 4 it must lie in the range 46 dB to 50 dB at 100 MHz, etc.

A well known category 6 male connector is the connector known as RJ45 that is described in the TEC 60603-7 standard. Such a connector is described in U.S. pat. No. 6238235.

That connector comprises a housing receiving the multi-pair data transmission cable and within which the outer sheath of the cable is removed so as to release the various conductors. The released conductors are placed in pairs in the order defined in the TIA/EIA 568 or ISO 11801 standards, for example, in an organizer element having four passages formed in an elongate piece, these passages receiving the pairs which they separate by electrically conductive portions. The conductor pairs project beyond the elongate piece in order to be fixed in parallel with one another in a terminal receiver element. This receiver element is provided with a row of orifices in one of its faces. These orifices receive insulation-displacing contacts of a housing engaged on the cap.

According to that document, the organizer element substantially reduces or even eliminates near-end crosstalk between pairs of conductors by providing an electrically conductive barrier inside the connector.

However, it has been found in such a connector that although standards do indeed require low levels of near-end crosstalk, they also require the individual levels of crosstalk between the various pairs to be adjusted to within relatively tight ranges.

The arrangement described in that prior patent does not provide an acceptable solution to this problem. The organizer element and the receiver element therein are of dimensions that are fixed by the standardized dimensions of the connector and they are common to all of the pairs. It is therefore not possible to perform any individual adjustment relating to each pair.

Assuming that the component elements are dimensioned so as to obtain appropriate near-end crosstalk ranges with one particular type of cable, then when a cable is used that is made up of conductors that are different and that therefore present different capacitances, the arrangement is no longer suitable and therefore needs to be specially studied and re-designed for each type of cable.

### OBJECTS AND SUMMARY OF THE INVENTION

The invention solves these problems, and to do so it provides a modular connector for a data communications system, the connector comprising a cap receiving a multi-pair cable, and in which the conductor pairs are released from an outer sheath of the cable in order to be fixed in a terminal receiver element that co-operates with a housing carrying insulation-displacement contacts, the connector also having a conductive arrangement placed between the end of said sheath and said receiver element and separating each pair of conductors, wherein said conductive arrangement is constituted by tubular shields each receiving one pair of conductors and each of a length that is adjusted individually so as to obtain determined levels of near-end crosstalk between pairs.

Each of said shields may be constituted by a tube of conductive material, a sheet of conductive material wound around each pair, or conductive material extruded over each pair.

A manufacturing arrangement is thus provided which is particularly simple and which makes it possible to adjust the near-end crosstalk of the connector in a manner that is particularly easy: merely cutting the shields to the appropriate lengths.

This arrangement also makes it possible to adapt to a variety of different standardized ranges for near-end crosstalk levels. It makes it possible to perform adjustment with the desired degree of fineness.

### BRIEF DESCRIPTION OF THE DRAWINGS

The invention is described below in greater detail with reference to figures which merely show a preferred embodiment of the invention.

FIG. 1 is an exploded perspective view of a connector in accordance with the invention.

FIG. 2 is a fragmentary exploded perspective view of the connector.

FIG. 3 is a view equipment to FIG. 2, in the assembled state.

### MORE DETAILED DESCRIPTION

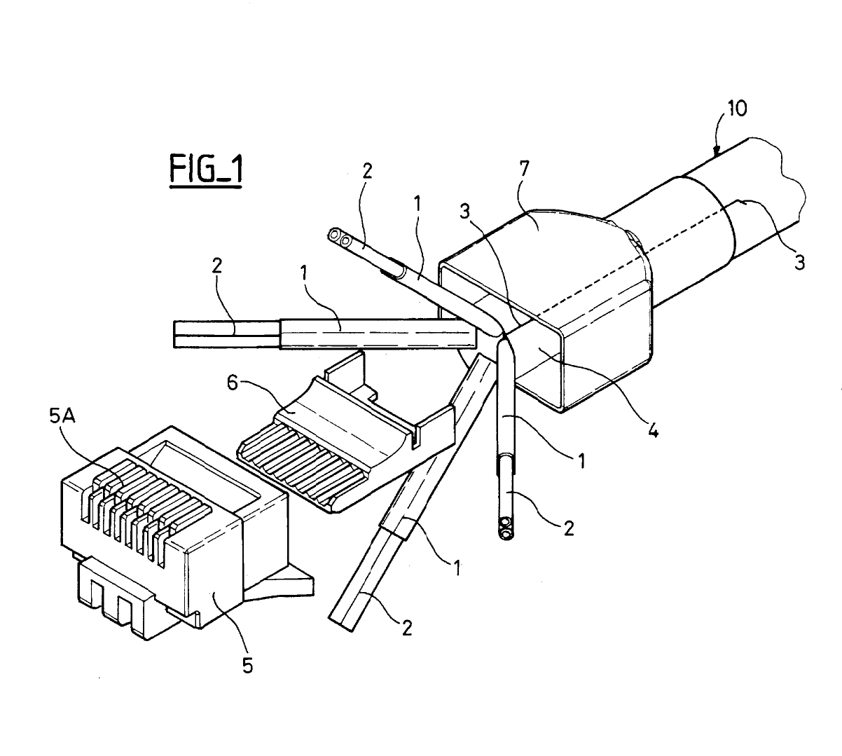

As shown in FIG. 1, an RJ45 type modular connector of a data communications system comprises a cap 7 of insulating or conductive material receiving a multi-pair cable 10 which is held in the cap 7. In conventional manner the cable 10 is made up of insulated conductors C1 to C8 which are twisted together in pairs, with the set of these conductors being covered in an insulating outer sheath 4. The cable also has a drain conductor 3.

Close to the end of the cap 7, the conductor pairs 2 are released from the outer sheath 4 of the cable so as to be fixed in a terminal receiver element 6.

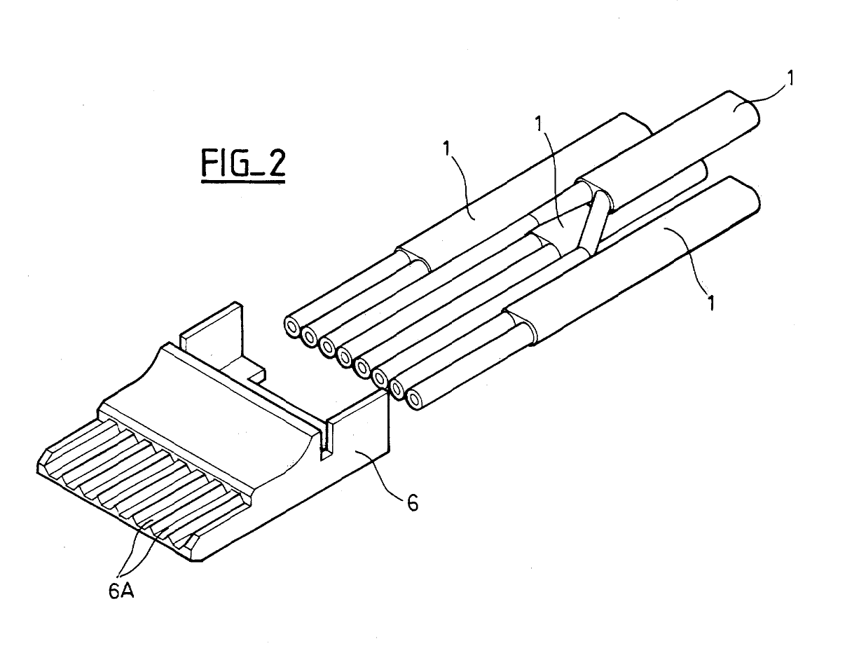

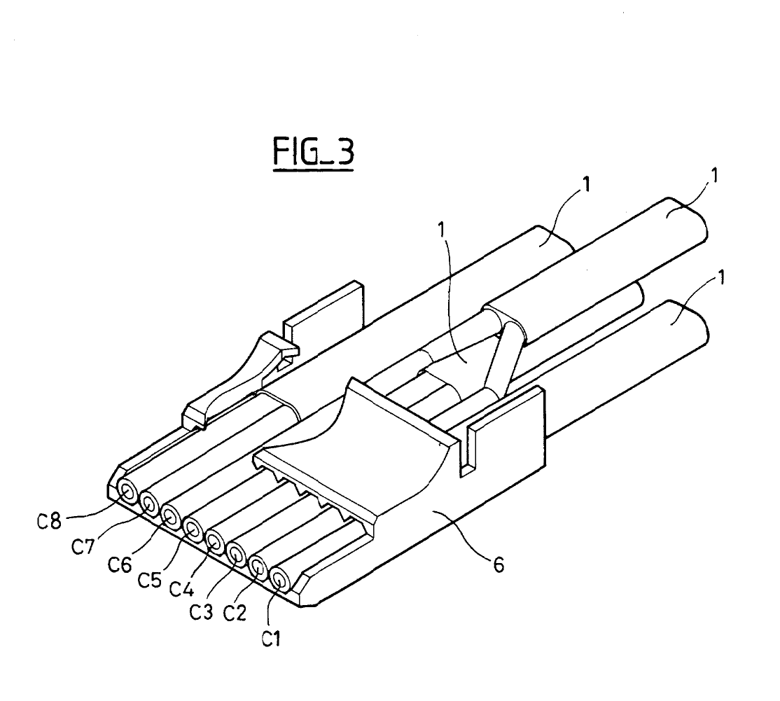

The receiver element 6 is shown more particularly in FIGS. 2 and 3.

The conductors of the pairs 2 are placed in parallel therein and they are inserted in grooves 6A where they are positioned so as to press against the bottoms of the grooves. The conductors C1 and C2 form pair No. 2, conductors C3 and C6 pair No. 3, conductors C5 and C4 pair No. 1, and conductors C7 and C8 pair No. 4.

A housing 5 that can be seen in FIG. 1 carries insulation-displacement contacts 5A is then engaged on the receiver element 6 and the contacts 5A when pressed by a suitable tool perforate the insulation of the conductors C1 to C8 and thus provides the electrical connection at the outlet from the connector.

The invention consists in inserting tubular shields 1 on the pairs 2 between the end of the sheath 4 and the inside of the receiver element 6, each tubular shield 1 receiving a pair of conductors and being of a length that is adjusted individually so as to obtain a determined level of near-end crosstalk between pairs.

Each of said shields 1 can be constituted by a tube of conductive material, preferably made of metal, a sheet of conductive material, preferably made of metal, wound around each pair, or a conductive material extruded onto each pair.

Near-end crosstalk in the connector 10 can thus be adjusted by adjusting the lengths of the shields 1. At the location where these shields 1 are disposed, the conductors are parallel, and it is at this location where near-end crosstalk is strongest when there are no shields. By means of the invention, only the segments of conductors that are not covered in the shields 1 are involved in near-end crosstalk between pairs. By shortening or lengthening these uncovered segments, i.e. by increasing or decreasing the lengths of the shields 1, and by performing tests, it is thus possible to adjust near-end crosstalk between pairs to lie within the crosstalk ranges established by standards.

What is claimed is:

1/ A modular connector for a data communications system, the connector comprising a cap receiving a multi-pair cable, and in which the conductor pairs are released from an outer sheath of the cable in order to be fixed in a terminal receiver element that co-operates with a housing carrying insulation-displacement contacts, the connector also having a conductive arrangement placed between the end of said sheath and said receiver element and separating each pair of conductors, wherein said conductive arrangement is constituted by tubular shields each receiving one pair of conductors and each of a length that is adjusted individually so as to obtain determined levels of near-end crosstalk between pairs.

2/ A modular connector according to claim 1, wherein each of said shields is constituted by a tube of conductive material.

3/ A modular connector according to claim 1, wherein each of said shields is constituted by a sheet of conductive material wound around each pair.

4/ A modular connector according to claim 1, wherein each of said shields is constituted by a conductive material extruded onto each pair.
